(19) United States
(12) Patent Application Publication
(10) Pub. No.: US 2010/0078540 A1
(43) Pub. Date: Apr. 1, 2010

(54) Safety retention device for an actuator

(76) Inventor: Agustin Mariano Martin Hernandez, Getafe (ES)

Correspondence Address: WENDEROTH, LIND & PONACK, L.L.P., 1030 15th Street, N.W.,, Suite 400 East, Washington, DC, 20005-1503, US

(21) Appl. No.: 12/318,795

(22) Filed: Jan. 8, 2009

(30) Foreign Application Priority Data
Sep. 30, 2008 (ES) P200802765

(51) Int. Cl. F16M 13/02

(52) U.S. Cl. 248/317

(57) ABSTRACT

Applicable in installations that comprise a reaction bar (1) located above an actuator (4), and both attached to a first piece (2) and to a second piece (3) for producing the relative displacement between the first piece (2) and the second piece (3). It also comprises two supports (6) which are fixed to the reaction bar (1) and which, by means of some vertical arms (7), support two horizontal bars (8) which are located facing and parallel to the lateral sides of the actuator. It includes a cable (9), located around each one of the horizontal parallel bars (8), whose ends are fixed to the lateral sides of the actuator (4) so that, when disconnection takes place of the actuator from the first piece (2) or second piece (3), said actuator (4) is kept retained by means of the safety device.

### OBJECT OF THE INVENTION

As stated in the title of this descriptive specification, the present invention relates to a safety retention device for an actuator, in which said actuator is to be found fixed to two pieces in order to produce the relative displacement between them. The safety device is intended for carrying out the securing of the actuator when disconnection of it takes place with respect to one of said pieces; and it has the aim of simplifying and reducing the weight and complexity of the structure of the safety device.

The invention is consequently applicable to any sector of industry in which it is sought to prevent the total or partial falling of the actuator in the event of it being accidentally disconnected from any of its fastenings on the pieces to which it is attached, and more particularly those devices where the total or partial falling of the actuator can have an adverse impact on the safety of the element on which the installation is carried out.

The invention is especially applicable to the aerospace industry, for those actuators that are intended for tilting mobile elements with respect to fixed elements, such as the actuators for elevators, flaps, etc.

Moreover, the invention can be applicable to the shipbuilding industry, especially in the manufacture of submarines where space is also limited, with considerations similar to the aeronautical industry.

It can also be pointed out that the invention is applicable to hydraulic systems that include sluices that are moved by means of actuators, in applications of great responsibility, such as dams, thermal/nuclear power plants, etc., where the actuator could cause blockages that can lead to overpressures in the system.

Likewise, the invention can be applicable to robotics, both for industrial production plants and for autonomous equipment, such as for example surveillance/exploration robots, etc., or to the cranes and elevation systems industry with an impact on human safety, such as for example operators or people not involved in the functioning of the machine.

### BACKGROUND OF THE INVENTION

The nearest background to the invention consists of patent document EP1677011, which describes a safety retention device for an actuator that is applied in installations in which the actuator is fixed to two pieces for producing the relative displacement between both, with a reaction bar being provided above the actuator, which is also rotary coupled to the pieces to which the actuator is attached, in such a way that the device comprises an upper part that is fixed on the reaction bar, and which also supports two lateral arms which clasp at least part of the lateral sides of the actuator, said lateral arms including some windows which are traversed by some safety bolts joined to the lateral sides of the actuator, such that each window has dimensions larger than the transverse cross-section of the safety bolt passing through it so that the safety bolt is permanently arranged without making contact with the edges of said window when the actuator is coupled to said pieces, even during the movements of the actuator. The windows are provided with a horizontal extension such that their side edges do not make contact with said bolt when disconnection takes place of the actuator with at least one of said pieces. So, by means of the device described, owing to the dimensioning of the window, it is possible to control the movements of the actuator that are produced in the event of accidental disconnection of one or both of its coupling points.

Moreover, said bolts incorporate some widenings at their free end in order to control the lateral movements of the actuator, which increases the weight and complexity of the bolts, apart from the fact that said safety bolts have to be capable of supporting the weight of the actuator in the event of disconnection.

One of the pieces to which the actuator is attached is a fixed piece, while the other one is a mobile piece, such that in the event of disconnection of the fixed piece occurring, when displacement of the mobile piece is effected, it pulls on the actuator, which gives rise to the situation that the possible pulling movements on the actuator body are of considerable length, so large dimensioned windows need to be made through which the bolt can pass, which means that its weight is consequently large.

Another consequence of the long pulling movements is that the loads of the weight of the actuator applied at the ends of the window generate forces that are very decentered with respect to the upper part of the safety device, and therefore means of reinforcement have to be included in the unit so that it can support said loads, which implies an increase in weight.

On the other hand, it can be stated that in the event that vibrations are produced during the disconnections, the actuator bolts could produce a drumming effect on the window of the device, which is an unfavorable condition.

It can finally be pointed out that, in order to permit maintenance or detachment of an actuator, provision has been made for the lower part of the windows to include an articulated section so that an opening can be made in the window in order to allow the bolts can pass and the actuator can thus be extracted. This configuration represents a design that requires additional reinforcements in the articulated section and the window, which implies an increase in weight.

### DESCRIPTION OF THE INVENTION

In order to solve the drawbacks and achieve the objectives stated above, the invention has developed a new safety retention device for an actuator, which is applied in installations that comprise a reaction bar which is rotary coupled to a first piece and a second piece, in such a way that the reaction bar is arranged above an actuator, which is also attached to the first and second piece so that, when the actuation of the actuator is effected, the relative displacement is produced between the first and second piece. The main novelty of the invention lies in the fact that the safety device comprises at least two supports which are fixed to the reaction bar and which, by means of some vertical arms, support two horizontal bars which are located facing and parallel to the lateral sides of the actuator, in such a way that the safety device also includes at least one cable located around each one of the horizontal parallel bars. The ends of each of said cables are fixed to the lateral sides of the actuator so that, when disconnection takes place of the actuator from the first or second piece, said actuator is kept retained by means of the safety device in such a way that it is left hanging from the cables on the parallel horizontal bars, which are in turn supported by the supports via the vertical arms.

This device is lighter and simpler than the windows of the device described in the state of the art.

The ends of the cables are preferably attached to the upper part of the lateral sides of the actuator and in the vertical part of its centre of gravity, in order to facilitate the retention of the actuator by means of the safety device in the event of disconnection of the actuator occurring.

The fixing of the ends of the cables in the lateral sides of the actuator is done in such a way that one of its ends is permanently attached while the other one is fixed in a detachable way, such as for example by means of screws, so that a very simple structure is provided in order to permit maintenance and detachment of the actuator to be carried out.

In the event of disconnection of the actuator, its weight will be left hanging from the cables, the lateral movements thus being limited.

In the preferred embodiment of the invention, the cables are made of steel which grants a certain flexibility, permitting the damping of possible vibrations, in such way that the drumming effect on the safety device is reduced and can even be annulled.

The supports comprise an upper part that is arranged transversely to the reaction bar, and whose ends project with respect to the lateral sides of the actuator, so that the vertical arms are fixed to those ends and run parallel to said lateral sides of the actuator. The supports also comprise a lower part that is coupled to the upper part forming a securing clamp for the supports to the reaction bar, the safety device remaining perfectly attached to the reaction bar.

The dimensions of each one of the described elements of the safety device of the invention have to be such that they permit the correct displacement of the actuator in the event of a pulling movement being produced on it when becoming disconnected from the fixed part and remaining connected to the mobile part. These dimensions also have to permit the normal functioning of the actuator.

In the preferred embodiment of the invention the supports are fixed in proximity to the ends of the reaction bar which permits a dimensioning of the safety device that is adequate for permitting all the movements of the actuator mentioned above to be carried out.

Below, in order to facilitate a better understanding of this descriptive specification and forming an integral part thereof, a series of figures is attached in which the object of the invention has been represented by way of illustration and non-limiting.

### BRIEF DESCRIPTION OF THE FIGURES

FIG. 1.—Shows a side-on schematic view of the device of the invention.

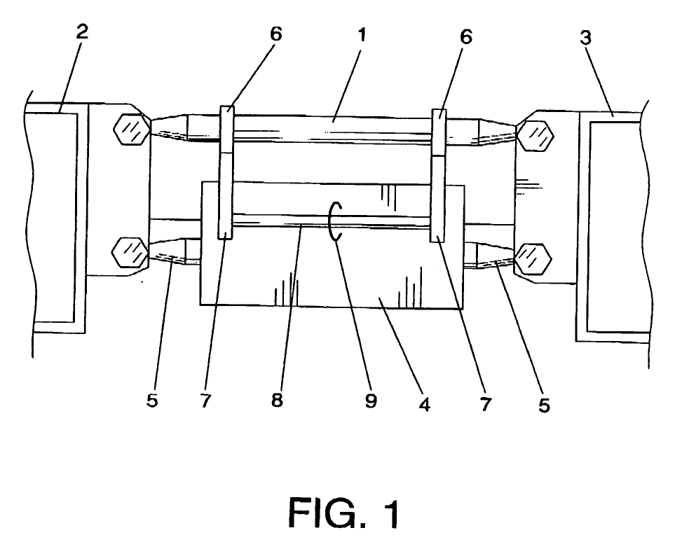

FIG. 2.—Shows a schematic view according to a transverse cross-section of the device of the above figure.

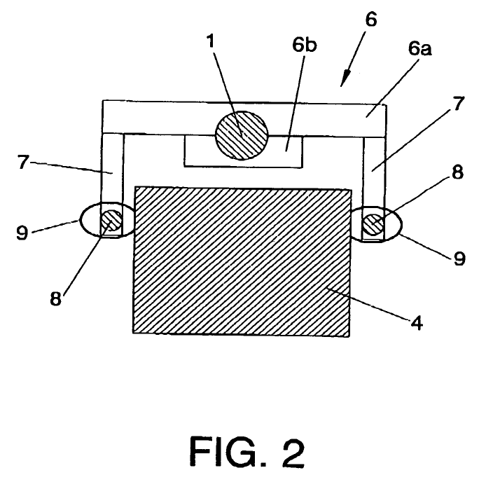

### DESCRIPTION OF THE PREFERRED FORM OF EMBODIMENT

A description of the invention is made forthwith, with the aid of the figures mentioned above.

As already mentioned, the device of the invention is applicable in installations that are fitted with a reaction bar 1, whose ends are fixed to a first piece 2 and to a second piece 3, in such a way that the first piece 2 is fixed and the second piece 3 is mobile.

Included underneath the reaction bar 1 is an actuator 4, whose ends 5 are also attached to the first piece 2 and second piece 3.

So, the actuation of the actuator 1 provokes a displacement of relative rotation between the first piece 2 and second piece 3, for which the attachments both of the actuator 4 and of the reaction bar 1 are articulated on the first piece 2 and second piece 3.

The safety device of the invention comprises two supports 6 to which are attached two pairs of vertical arms 7 in the lower part of which are supported two horizontal bars 8 which are located facing and parallel to the lateral sides of the actuator 4, for which the supports 6 consist of an upper part 6a arranged transversely to the reaction bar 1, and with a length such that its ends allow the fixing of the vertical arms 7 in such a way that they run parallel to lateral sides of the actuator 4, which means that the horizontal bars 8 are located parallel and facing said lateral sides of the actuator 4.

Moreover, each of the supports 6 comprises a lower part 6b which is coupled to the upper part by conventional means, forming a clamp which materializes the fixing of the supports 6 on the reaction bar 1; in such a way that the fixing is materialized of the safety device on the reaction bar 1.

Furthermore, provided around each of the horizontal bars 8 is a steel cable 9 whose ends are fixed to the lateral sides of the actuator 4 such that one of said ends is fixed permanently and the other one in a detachable way, for example by means of screws. This latter characteristic allows the actuator 4 of the safety device of the invention to be detached so that operations of maintenance, repairs or replacements of the actuator can be carried out.

The dimensions of all the elements described have to be adequate for allowing the normal movement of the actuator designed for producing the rotation of the second piece 3 without the safety device interfering with the actual movements of the actuator.

Moreover, in the event of disconnection taking place of the actuator with the first piece 2 or the second piece 3, it remains hanging by the steel cables 9 on the horizontal bars 8, which are in turn supported by the reaction bar 1 via the supports 6 and vertical arms 7. This configuration limits the lateral movements that can be produced in the actuator 4.

In the event in which the actuator comes loose from the mobile second piece 3, this does not represent a major problem since the actuator remains inactive supported in the manner already mentioned, but in the event in which the actuator 4 comes loose from the fixed first piece 2, the actuator continues to be connected to the mobile second piece 3, with which the displacement of the mobile second piece 3 (which could be produced by another safety actuator) could provoke a pulling movement on the actuator, so that the dimensioning of the device has to be adequate for permitting said pulling movement to be performed, during which the steel cables 9 run along the horizontal bars 8.

Therefore, the new configuration of the safety device has been simplified and its weight has been reduced with respect to that provided in the state of the art.

1. SAFETY RETENTION DEVICE FOR AN ACTUATOR, applicable in installations that comprise a reaction bar (1) which is rotary coupled both to a first piece (2) and to a second piece (3) and which is provided above an actuator (4) which is also rotary coupled to the first piece (2) and second piece (3), for which, when the actuator (4) is actuated, the relative displacement is produced between the first piece (2) and second piece (3); the device comprising:
at least two supports (6) which are fixed to the reaction bar (1) and which, by means of vertical arms (7), support two horizontal bars (8) which are located facing and parallel to the lateral sides of the actuator (4);
at least one cable (9) located around each one of the horizontal parallel bars (8), and whose ends are fixed to the lateral sides of the actuator (4) so that, when disconnection of the actuator (4) from the first piece (2) or second piece (3) takes place, said actuator (4) is kept retained by means of the safety device.

2. SAFETY RETENTION DEVICE FOR AN ACTUATOR, according to claim 1, wherein the ends of the cables (9) are attached to the upper part of the lateral sides of the actuator (4) and in the vertical plane that contains its centre of gravity.

3. SAFETY RETENTION DEVICE FOR AN ACTUATOR, according to claim 1, wherein one of the ends of the cables (9) is connected to the lateral sides of the actuators (4) permanently, while its other end is fixed in a detachable way.

4. SAFETY RETENTION DEVICE FOR AN ACTUATOR, according to claim 1, wherein the cables (9) are made of steel.

5. SAFETY RETENTION DEVICE FOR AN ACTUATOR, according to claim 1, wherein the supports (6) comprise an upper part (6a), transverse to the reaction bar (1), and whose ends project with respect to the lateral sides of the actuator (4), so that the vertical arms (7) are fixed to said ends and run parallel to said lateral sides of the actuator (4); the supports (6) furthermore comprising a lower part (6b) that is coupled to the upper part (6a) forming a securing clamp for the supports (6) on the reaction bar (1).

6. SAFETY RETENTION DEVICE FOR AN ACTUATOR, according to claim 1, wherein the supports (6) are fixed in proximity to the ends of the reaction bar (1).

7. SAFETY RETENTION DEVICE FOR AN ACTUATOR, according to claim 5, wherein the supports (6) are fixed in proximity to the ends of the reaction bar (1).
